(19) United States
(12) Patent Application Publication
(10) Pub. No.: US 2013/0118851 A1
(43) Pub. Date: May 16, 2013

(54) MODULAR SPRAG CLUTCH CAGE

(71) Applicant: Schaeffler Technologies AG & Co. KG, Herzogenaurach (DE)

(72) Inventor: Eric S. NELSON, CHARLOTTE, NC (US)

(73) Assignee: Schaeffler Technologies AG & Co. KG, Herzogenaurach (DE)

(21) Appl. No.: 13/677,726

(22) Filed: Nov. 15, 2012

Related U.S. Application Data
(60) Provisional application No. 61/559,905, filed on Nov. 15, 2011.

(51) Int. Cl. F16D 15/00

(52) U.S. Cl. CPC F16D 15/00
USPC 192/45.1; 29/453

(57) ABSTRACT

A cage for a one-way clutch that is made of individual interlocking links. The cage links forms a continuous chain which is arranged on a shaft and housed within an associated outer ring. The cage links have connecting members and receiving grooves. The connecting members of one cage link are snapped into the receiving grooves of another cage link to form the continuous chain for different diameters. Sprags and/or load bearing rollers, along with spring elements, are arranged within each cage link.

### CROSS-REFERENCE TO RELATED APPLICATIONS

This application claims the priority of U.S. 61/559,905 filed Nov. 15, 2011, which is incorporated by reference herein.

### FIELD OF INVENTION

The present invention relates generally to clutches and more particularly to a cage comprised of individual interconnected cage links for one-way clutches.

### BACKGROUND OF THE INVENTION

Typically, one-way clutches, which freewheel in one rotational direction and transmit torque in the other direction, utilize cages to hold sprags or rollers. One-way clutches are used for a wide variety of applications including industrial power transmission equipment, automobile transmissions, torque converters, material handling equipment, and manufacturing equipment. Regularly, one-way clutches are arranged on a shaft of the application and include an outer ring. Depending on the application, the cage can be applied directly onto the shaft or the cage can also include an inner ring. The cages used in known one-way clutches, which can, for example, be made of molded polymer or formed metal, include one-piece cages, two-piece cages, and cages made of links assembled together. Springs can be anchored to the cage or, alternatively, a separate ring can be incorporated to supply a spring force to the sprags or the rollers that are arranged within the cage.

The tooling costs associated with the production of a one-piece cage are usually a large initial investment. Cages used in one-way clutches are typically produced from tooling dedicated to the production of cages that can accommodate only a single shaft diameter and a single outer ring diameter. Thus, the tooling cost associated with the production of cages for one-way clutches arranged on different shaft and outer ring diameters can require a large initial investment as separate dedicated tooling is required to produce cages for different shaft and outer ring diameters.

Also, the spring(s) used in existing one-way cages add to the expense of the cage because the springs are expensive, require separate assembly, are difficult to install in the cage, and require separate inspection.

Moreover, external of the cage, centering washers are regularly used with one-way clutch cages to supply a requisite radial support between a shaft and an outer ring. However, centering washers add to the expense and the complexity of a clutch assembly as the centering washer has narrow tolerances for accurately centering the shaft in an outer race. A plain bearing material, such as brass or bronze, is often used for the washer. Stamped steel washers can also be used. Typically, stamped steel washers are plated with a cupric plain bearing alloy to reduce sliding friction. However, the alloys and tight tolerances required make the centering washers expensive. Furthermore, the centering washer(s) is placed alongside the one-way clutch cage, which adds to the overall axial space requirement of the one-way clutch.

See, for example, U.S. Pat. No. 5,651,438, which discloses interlocking cage segments for roller clutches. The cage segments are positioned between an outer cam race and an inner pathway race and have an engaging member, which engages a receiving member on an adjacent cage segment. The cage segments also include a roller positioned within the cage and a resilient means, such as a spring, positioned within the cage to bias the roller.

Also, see, for example, U.S. Pat. No. 4,555,002, which discloses sectioned cage construction for a one-way clutch. Here, the cage has adjoinable sections with abuttable flanges thereon. Rollers are arranged within each cage segment and a spring is partially arranged within each cage section and snap-fitted around the flanges to join the cage sections together.

Moreover, see, for example, U.S. Pat. No. 3,702,649, which discloses a one-way clutch that has sprags arranged between an inner race and an outer race. Studs project axially from the sprags and springs are mounted on the studs.

### SUMMARY OF THE INVENTION

The present invention is directed to a cage for a one-way clutch that is made of individual interlocking links. The chain of cage links forms a continuous loop to fit around a given shaft and is housed within an associated outer ring. The cage can accommodate a broad range of diameters of devices by varying the number of links used in a cage assembly. For example, increasingly large shaft diameters can be accommodated by increasing the number of links in the cage. The tooling cost is minimized as the cage is adaptable to accommodate various diameters. Also, a spring element can be molded integral to each cage link without an added purchasing or assembly expense. Alternatively, a metal spring element could be used.

The cage allows for the incorporation of sprags and/or load bearing rollers to act on the raceways, between which the cage is arranged. To center the cage containing only sprags a centering washer can be used, however, the rollers can be used in place of centering washers, which reduces friction, simplifies clutch design, and reduces purchasing and inspection cost. The rollers provide radial support between a shaft or an inner ring and an outer ring in a compact and efficient manner and the rollers reduce the overall assembly width of the cage. The ratio of cage links containing rollers to sprags can be adjusted depending on the application.

Broadly, the present invention relates to a cage for a one-way clutch, which comprises a plurality of cage links that have connecting members and receiving grooves. The connecting members of one of the cage links are snapped into the receiving grooves of another of the cage links so as to form an endless chain of cage links. The connecting members have an axis of rotation and are rotatable about the axis of rotation in both a positive and a negative direction. The cage links are constructed so that the links can be combined to form endless chains of various lengths and diameters. The cage also comprises a spring element arranged within each cage link and a rotatable element, which can be a sprat and/or a roller, arranged within each cage link. The cage links can be molded of a polymer resin or other suitable material.

The cage link can have a substantially U-shaped opening formed form a first sidewall, a second sidewall, spaced from the first sidewall, and a base that connects the first sidewall and the second sidewall together. A first end of the first sidewall extends from a first end of the base in a first direction and a first end of the second sidewall extends from a second end of the base in the first direction.

The connecting members can be extensions which have substantially circular ends that extend in a second direction from the first end of the first sidewall and the first end of the second sidewall. The receiving grooves can be substantially C-shaped and can be formed in the second end of the first sidewall and the second end of the second sidewall.

The cage links can also have a first flange formed integral with one of the connecting members that extend from the first end of the base in the second direction and the cage links can have a second flange formed integral with another of the connecting members that extend from the second end of the base in the second direction.

The spring element can be molded integral to each cage link. More specifically, the spring element can be molded integral to the base of each cage link. Also, the spring element can be made of steel.

In an embodiment, only sprags can be utilized and arranged within each of the cage links. Alternatively, in another embodiment, both sprags and rollers can be incorporated into the cage. Here, each cage link has only a single rotatable element with the roller arranged in one of the cage links and the sprag arranged in another of the cage links adjacent to the one of the cage links.

Additionally, the present invention relates to a method for assembling a cage of a one-way clutch, which has a plurality of cage links and rotatable elements. The method comprises the steps of arranging a rotatable element in each cage link, and snapping the cage links together to form an endless chain. The rotatable element can be a sprag and/or a roller. Further, the rotatable element arranged in one of the cage links can be a roller and the rotatable element arranged in another of the cage links, which is adjacent to the one of the cage links, can be a sprag.

The cage can further comprise spring elements, which are molded integral to each of the cage links. Alternatively, the cage can further comprise spring elements, which are arranged within each of the cage links.

### BRIEF DESCRIPTION OF THE DRAWINGS

The present invention will be further understood and appreciated by reading the following description in conjunction with the accompanying drawings, in which:

FIGS. 1a, 1b, 1c illustrate an end view, an enlarged detail view (Detail A), and a cross-sectional view along line I-I in FIG. 1b of a known one-way clutch cage design;

FIG. 1d illustrates a front view of a known centering washer;

FIGS. 2a, 2b, 2c illustrate a cage link of the present invention for use with sprags;

FIGS. 3a, 3b, 3c, 3d illustrate a front view, a perspective view, a cross-sectional view along line III-III in FIG. 3d, and an end view of an assembly of the cage links containing sprags;

FIGS. 4a, 4b illustrate front views and perspective views of assemblies of the cage links shown in FIGS. 2a, 2b, 2c for use with one-way clutches of different diameters;

FIGS. 5a, 5b, 5c illustrate a cage link of the present invention for use with rollers;

FIG. 6a, 6b, 6c illustrate a front view, a cross-sectional view along line V-V of FIG. 6c, and an end view of an assembly of cage links for sprags interspersed between cage links for rollers; and

FIG. 7 illustrates a cross-sectional view of the sprag and roller assembly from FIG. 6 as installed on an outer ring and a shaft.

### DETAILED DESCRIPTION OF THE INVENTION

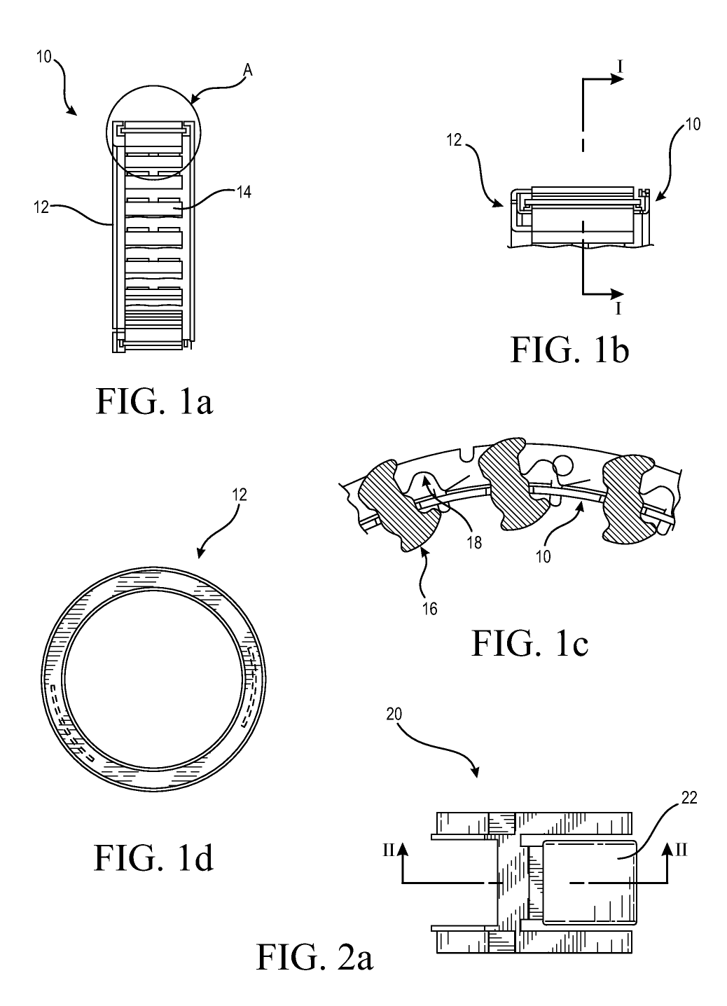

FIGS. 1a and 1b illustrate a known cage 10 and a known centering washer 12 for a one-way clutch. FIG. 1a is an end view of the cage 10. The cage 10 has pockets 14 in which sprags 16 and springs 18 can be inserted. FIG. 1b is an enlarged view of detail A from FIG. 1a. FIG. 1c illustrates a sectional view along line 14 of FIG. 1b showing the sprags 16 and the springs 18 arranged within the cage 10. FIG. 1d illustrates a front view of the centering washer 12.

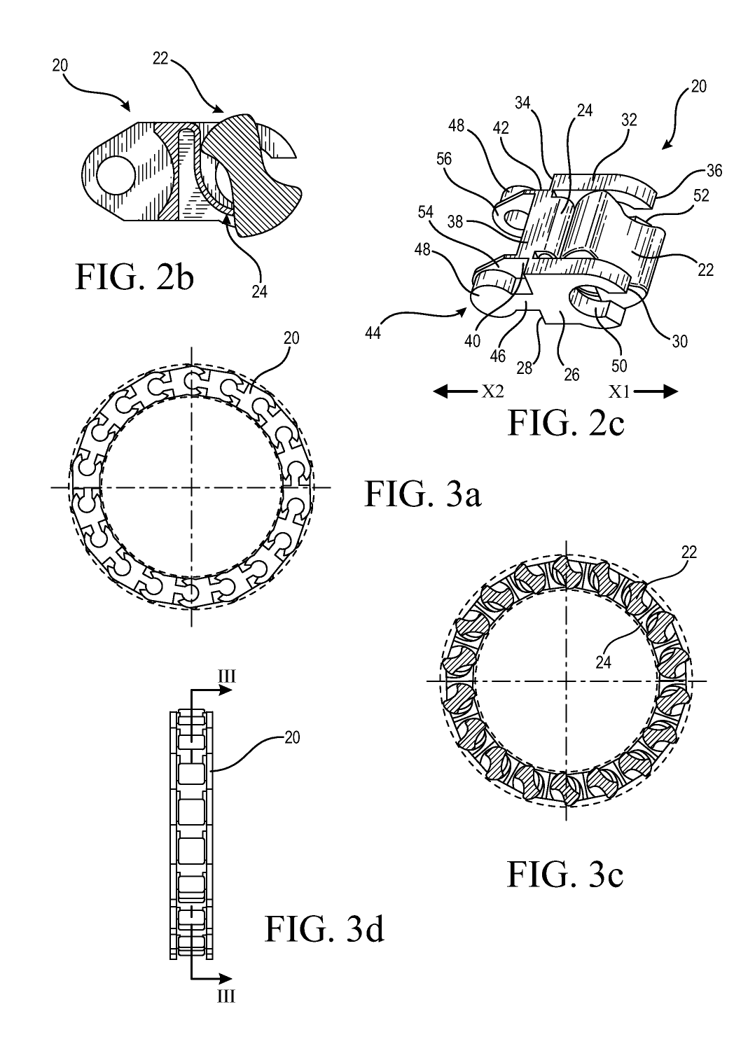

FIG. 2a is a top view of a cage link 20 of a first embodiment of the present invention, which is intended for use with a sprag 22. FIG. 2b is a cross-sectional view along the line II-II in FIG. 2a of the cage link 20 with the sprag 22 arranged therein. In FIG. 2b, the cage link 20 has a spring element 24, which is molded integral to the cage link 20. The spring element 24 extends in a curved manner from the cage link 20 to provide a sloped surface for the sprag 22 to rotate against. However, any known spring shape can be used. The spring element 24 imparts a force on the sprag 22 to bias the sprag 22. Alternatively, the spring element does not have to be molded integral to the cage link 20 and the spring element can be a metal spring.

FIG. 2c is a perspective view of the cage link 20 with the sprag 22 arranged therein. The cage link 20 has a substantially U-shaped opening formed form a first sidewall 26, which has a first end 28 and a second end 30, a second sidewall 32, which has a first end 34 and a second end 36, spaced from the first sidewall 26, and a base 38, which has a first end 40 and a second end 42 that connects the first sidewall 26 and the second sidewall 32 together. The second end 30 of the first sidewall 26 extends from the first end 40 of the base 38 in a first direction X1 and the second end 36 of the second sidewall 32 extends from the second end 42 of the base 38 in the first direction X1. The cage link 20 has connecting members 44, which are extensions 46 with substantially circular ends 48 that extend in a second direction X2 from the first end 28 of the first sidewall 26 and the first end 34 of the second sidewall 32. As can be seen in FIG. 2c, the first sidewall 26 has a substantially C-shaped groove 50 formed in the second end 30 of the first sidewall 26 and the second sidewall 32 also has a substantially C-shaped groove 52 formed in the second end 36 of the second sidewall 32. The C-shaped grooves 50, 52 are formed so that the substantially circular ends 48 of an adjoining cage link 20 can be snapped into the C-shaped grooves 50, 52 of the cage link 20. The C-shaped grooves 50, 52 and the substantially circular ends 48 of the cage links 20 are configured to permit the cage links 20 to be interconnected to form continuous chains of different diameters. Moreover, the cage links 20 have a first flange 54 formed integral with one of the extensions 46, which first flange 54 extends from the first end 40 of the base 38 in the second direction X2 and a second flange 56 formed integral with another of the extensions 46, which second flange 56 extends from the second end 42 of the base 38 in the second direction X2.

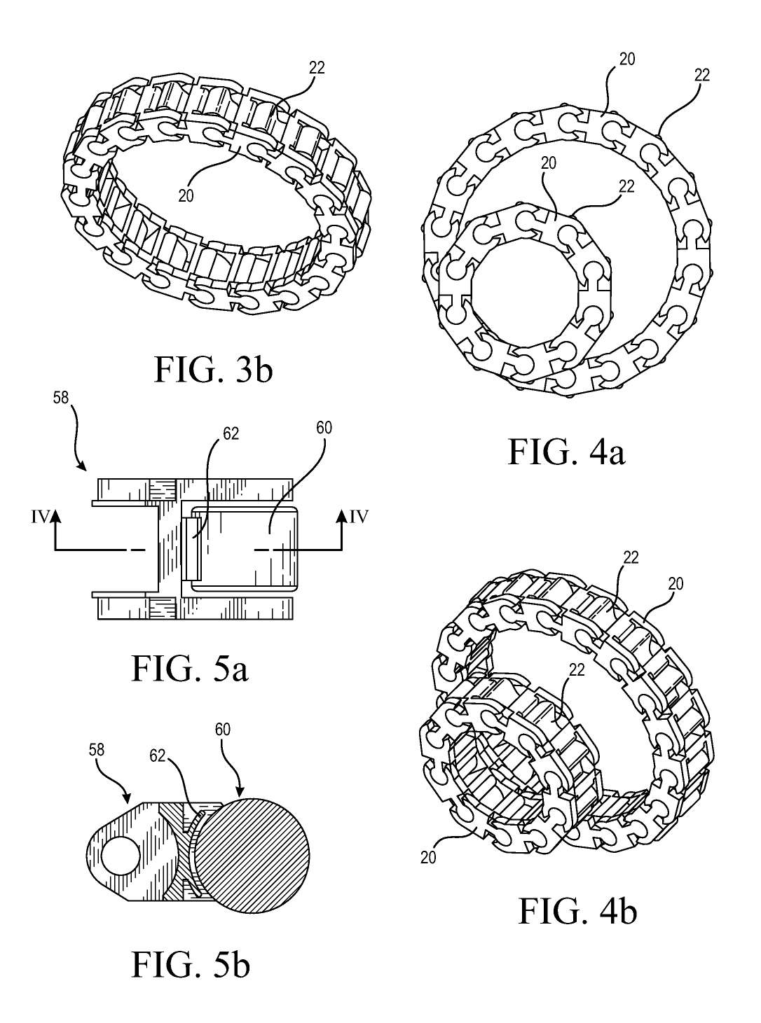

FIG. 3a shows a continuous chain of cage links 20 containing sprags 22 snapped together and ready for mounting. FIG. 3b is a perspective view of the continuous chain of cage links 20 containing sprags 22 snapped together. FIG. 3c is a cross-sectional view of the continuous chain of cage links 20 containing sprags 22 snapped together. FIG. 3d is an end of the continuous chain of cage links 20 containing sprags 22 snapped together.

FIG. 4a shows assemblies of the cage links 20 containing sprags 22 for use with clutches (now shown) of different diameters. FIG. 4b shows perspective views of assemblies of the cage links 20 containing sprags 22 of FIG. 4a for use with clutches (now shown) of different diameters.

FIG. 5a is a top view of a cage link 58 of a second embodiment of the present invention, which is intended for us with a roller 60. FIG. 5b is a cross-sectional view along line IV-IV in FIG. 5a of the cage link 58 with the roller 60 arranged within the cage link 58. In FIGS. 5a and 5b, the cage link 58 has a spring element 62 molded integral to the cage link 58. Alternatively, the spring element does not have to be molded integral to the cage link 58 and the spring element can be a metal spring. FIG. 5c is a perspective view of the cage link 58 with the roller 60 arranged within the cage link 58. The cage links 58 for rollers 60 are intended to be combined with cage links 20 for sprags 22. As such, the cage links 58 for rollers 60 and the cage links 20 for sprags 22 can be structurally identical with the exception being the integration of the spring element 24 or 62. As shown in FIG. 5c, the spring element 62 is formed integral with the cage link 58 and has a semi-circular shape to at least partially surround the roller 60. However, any suitable spring shape can be used.

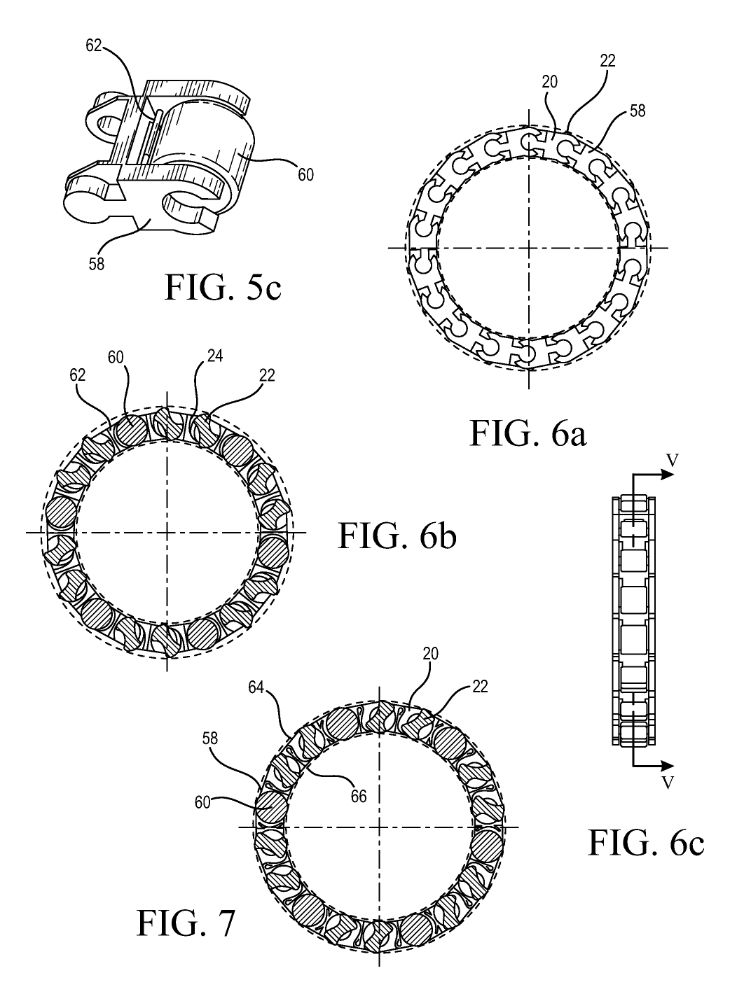

FIG. 6a shows a plurality of interconnected cage links 20 for sprags 22 and cage links 58 for rollers 60 (shown in FIG. 6b) that are connected together, forming an endless chain in a free-state. The cage links 58 containing rollers 60 provide radial shaft support. This enables the assembly to not require an external bearing or a centering washer. FIG. 6b is a cross-sectional side view of the continuous chain of cage links 20, 58 containing sprags 22 and rollers 60 snapped together taken along line V-V in FIG. 6c. FIG. 6c is an end view of FIG. 6a. FIG. 6c shows cage links 20, 58 containing sprags 22 and rollers 60. The cage links 58 containing rollers 60 are interspersed between the cage links 20 containing sprags 22.

FIG. 7 shows the assembly of the cage links 20 containing sprags 22 and the cage links 58 containing rollers 60 from FIGS. 6a-6c with the sprags 22 in position as installed on an outer ring 64 and a shaft 66. The sprags 22 in FIG. 7 are rotated to a ready position, compressing the spring elements 24.

The present invention has been described with reference to a preferred embodiment. It should be understood that the scope of the present invention is defined by the claims and is not intended to be limited to the specific embodiment disclosed herein.

### REFERENCE CHARACTERS

10 Cage

12 Centering Washer

14 Pocket

16 Sprag

18 Spring

20 Cage Link

22 Sprag

24 Spring Element

26 First Sidewall

28 First End

30 Second End

32 Second Sidewall

34 First End

36 Second End

38 Base

40 First End

42 Second End

44 Connecting Member

46 Extension

48 Circular End

50 C-Shaped Groove

52 C-Shaped Groove

54 First Flange

56 Second Flange

58 Cage Link

60 Roller

62 Spring Element

64 Outer Ring

66 Shaft

X1 First Direction

X2 Second Direction

What is claimed:

1. A cage for a one-way clutch, comprising:
a plurality of cage links having connecting members and receiving grooves, the connecting members of one of the cage links being snapped into the receiving grooves of another of the cage links so as to form an endless chain of cage links, and the connecting members, which have an axis of rotation, are rotatable about the axis of rotation in both a positive and a negative direction;
a spring element arranged within each cage link; and
a rotatable element arranged within each cage link.

2. The cage of claim 1, wherein the cage link has a substantially U-shaped opening formed from a first sidewall, a second sidewall spaced from the first sidewall, and a base that connects the first sidewall and the second sidewall together, the first sidewall extends from first end of the base in a first direction and the second sidewall extends from second end of the base in the first direction.

3. The cage of claim 2, wherein the connecting members are extensions having substantially circular ends which extend in a second direction from a first end of the first sidewall and a first end of the second sidewall.

4. The cage of claim 3, wherein the receiving grooves are substantially C-shaped and are formed in the second end of the first sidewall and the second end of the second sidewall.

5. The cage of claim 3, wherein the cage links have a first flange formed integral with one of the extensions, which first flange extends from the first end of the base in the second direction and the cage links have a second flange formed integral with another of the extensions, which second flange extends from the second end of the base in the second direction.

6. The cage of claim 1, wherein the spring element is molded integral to each cage link.

7. The cage of claim 6, wherein the spring element is molded integral to the base of each cage link.

8. The cage of claim 1, wherein the spring element is made of steel.

9. The cage of claim 1, wherein the rotatable element is a sprag.

10. The cage of claim 1, wherein the rotatable element is a roller.

11. The cage of claim 1, wherein a number of the cage links have a sprag as the rotatable element, and a further number of the cage links have a roller as the rotatable element.

12. The cage of claim 1, wherein the cage links are molded of a polymer resin.

13. The cage of claim 4, wherein the connecting members and the receiving grooves are configured to permit the cage links to be interconnected to form endless chains of different diameters with the diameters of the endless chains depending on a number of the cage links that are interconnected.

14. A method for assembling a cage for a one-way clutch, the method comprising the steps of:
providing cage links having connecting members and receiving grooves;
arranging a rotatable element in each cage link; and
snapping the cage links together by engaging the connecting members into the receiving grooves so as to form a continuous chain.

15. The method of claim 14, wherein the rotatable element is a sprag.

16. The method of claim 14, wherein the rotatable element is a roller.

17. The method of claim 14, wherein the rotatable element arranged in one of the cage links is a roller and the rotatable element arranged in another of the cage links is a sprag.

18. The method of claim 14, wherein the cage further comprises spring elements molded integral to each of the cage links.

19. The method of claim 14, wherein the cage further comprises spring elements arranged within each of the cage links.
